(19) United States
(12) Patent Application Publication
(10) Pub. No.: US 2010/0153359 A1
(43) Pub. Date: Jun. 17, 2010

(54) DISCOVERING A WORK OF ART

(76) Inventor: Sara Penco, Roma (IT)

Correspondence Address: Steinfl & Bruno, 301 N Lake Ave Ste 810, Pasadena, CA, 91101, US

(21) Appl. No.: 12/517,942

(22) PCT Filed: Nov. 6, 2007
(86) PCT No.: PCT/IT07/00778

§ 371 Date: Feb. 22, 2010

(30) Foreign Application Priority Data
Nov. 7, 2006 (IT) RM2006A000604

(51) Int. Cl. G06F 17/30

(52) U.S. Cl. 707/710; 707/E17.108

(57) ABSTRACT

The project represents an instrument that, by a filing of historical-icono graphic information and a software, provides a innovative support to the study, to the filing and to the diagnostics of manufacts in the field of art. The software researchs, within a database containing the files of all of those attributes that, in the long run, have characterized the iconography of a subject. These attributes, then, are often typical of a certain historical period and of a localized geographical area; therefore, they are underlined because they are a precious value for the manufact's diagnostics. For example, a saint can be represented with some attributes up to a certain age and then, maybe as a consequence of what decided during a Council, from that moment onwards the representation method changes: this element is very significant for the datation. Or a Saint, maybe even patron of a town, has been pictured by the utmost artists of that area, nevertheless he has remained unknown elsewhere: this element is very important for the localization of the commitment's area. Once the pictured character has been identified (in the case it deals with a saint, otherwise with any other represented subject), this system allows us to rediscover all of those historical hence “certain” elements allowing us to circumscribe the manufact to the historical and geographical period it belongs to. The system runs by the same principle even on other subjects (for example prophane iconography) and the database includes all of that historical information enabling the research about several typologies of manufacts (pictures, codici miniati, statues, bronzes, arazzi, incisions, objects, etc). Within the database there is also a “dynamic” file of the works. Hereafter we quote the most interesting ones from a historical-artistic point of view and their position. We also mention the lost ones. Images can be filed We foresee that the system compares the result of this first research with the files of two other databases: the one of the old “books of bills” of the painters (where we can find the list of commitments, the wages, etc.) and the one of the chemical characteristics of the pigments and of the executive techniques of the different artists (certain pigments are to be found just in certain areas and some caves expired since a long time ago; moreover, even the materials used by the artists are different according to the ages and the geographical areas: the most precious pigments were only used by the Master, while the pupils had to be satisfied with a less rich and expensive palette).

The project “Discovering a work of art”, by means of a informatized procedure and thanks to the patrimony of a very precious database, allows us to “rediscover” a significant deal of historical information lost in the long run and exposed to the forgetfulness of human nature.

It consists of a graphic interface (which can be used “in loco”or by internet) that thanks to the use of relational databases, classification algorithms, comparison and research of information based on data recursive visit schemes and of simple artificial intelligence instruments allows us to retrieve information about a work or a subject by the introduction of some elements or characters.

These parameters, called “input”, can be varied and completed by the equipe leading the software management during the enlargement of the research/study, even thanks to the information produced by the software itself. The procedure gains a sort of interactivity when the inserted news is able to bear a correlation with other ones.

The process takes place again and again up to the end of the data visit capabilities by the algorithms.

Interests, Functions and Innovativity

The project is oriented to provide a service that, taking advantage of the synergies we have at the “present state of technique” and harmonizing them in an intelligent comparison, has the aim of making the diagnostics of works of art (information retrieval, study, filing, etc) more “innovative” and “technological”.

The project relies on a complex information file—we will define as “certain elements”—which is the result of objective historical data and which is not exposed to arbitrary protest.

Therefore, for this reason the diagnostics realized by the system“Discovering a work of art” can deal as a “warranty” since the information that will be elaborated will build a patrimony which would have other ways given out to the waste of significant human energies as well as to the danger of meeting those oversights and forgetfulness which often brought to the “diagnostically” wrong way.

Therefore, the project boasts of a strong innovative contents as well as of the prestige of a major “safety” about diagnostics. These elements surely represent that aspect of usefulness and functionality qualifying the service. We should keep in mind that the field of art the use of information procedures represents itself an innovative instrument

Moreover, just because of the characteristics featuring its working procedure and “its own” mechanism, the range of mistakes gets suitably reduced as to warrant encouraging and assuring results about the “safety of the diagnosis”. What we mentioned above is safe even from the point of view of a stricter respect of the subject of the work of art and its historical reality. The higher functionality, giving out a more competitive diagnostics, since it is advanced and organized, becomes useful from all of the professional points of view, thus offering a safe. service, which can be tested and fulfilled in a quicker way than the present one. It uses instruments and techniques such as the computer and the organized data files, procedures such as the “intelligent comparison” of the information and its systematic re-exam, thus coming to the retrieval of those characters belonging to history-therefore subject to be lost in the long run- and to the discovery of new information. The latter are derived from an ordered procedure (algorithm), therefore of subject to oversights and able to verify contradictions and to integrate old information with new deductions.

Data Base Structure

The first data base is structured by means of many cards containing the files of all of the iconographi data featuring a subject, recognizing the characteristics according ages and geographical areas; within these cards we can fin a dynamic file including the manufacts of the most important artists who dealt with the subject.

These works have already been known and studied and they are the same ones we derived the iconographic study (subject of the research) and the list of the attributes (media to carry out the research) from.

We briefly refer to the attribution of the mentioned works to the filing purpose (whatever they are: canvas, frescoes, wooden or marmour statues, bronzes, ceramics, arazzi, reliquaries, sarcophagi, bassorilievi, codici miniati, Bibles, salteri, incisions and so on), to their original location, and whenever they do not coincide, to the present one. We also list important works which we know they exist although their location is unknown (lost works). By the interrogation of this database, the system allows us to identify the subject pictured in the work in study and by the comparison of the attributes it suggests a probable age of execution and a geographical placement.

For instance, if a saint has been worshipped just in a specific town and has the characteristic features of the representations marking a certain century, it will not be possible to set the work elsewhere or to date it back to a preceding age.

Therefore, the system underlines that these manufacts cannot belong to artists who never reached those places or those commits justifying their execution. As a consequence, we cannot list hereafter all of the synergies which can be applied to the system, since the fruitions are many and different and the strong innovative character will suggest new ones in the future.

That is why we decided to introduce just a sample enclosed to the term of the present document. It is a picture preserved at the Museum of Beaux Arts of Nantes, attributed to Giacinto Brandi and studied by a list of art historians quoted in the card next to the image.

The work is published as “San Girolamo” or “Sant'Onofrio”. We consider that both of the saints are two of the most famous, such that it sounds natural to take them as an example. Nevertheless in this card the picture is published with the two options. Following the studies carried out by the system “Discovering a work of art” we could state that the image represents Saint Onofrio. In fact the iconographic attributes we can trace the picture, are common to both of the subjects (the skull the book, the joint hands, the long beard, the nacked torso), but only Saint Onofrio has a garland around his sides.

Besides, the project foresees that the system “Discovering a work of art” be “instructed” to interact with a second database containing the files of all information coming to us by means of historical texts such as “Books of Bills” of the painters and “The Lives”by Vasari.

In fact in these texts we can trace highly precious information about the works made by the most important artists, in what age, for which commits and at which wages. Moreover, we also describe here the pictured subjects with their corresponding measures and the descriptions which are useful to find the works to be filed and the lost ones. Therefore, the interaction between the two databases allows us to realize and monitor a dynamic filing including the localization of known manufacts (with the place they were originally and, when it does not coincide, where they are kept at the moment); to find works previously “identified” in a wrong way and which cannot be found properly and, at least, to find other ones seemingly made but whose placement is unknown to us at the moment (if a Saint Veronica is interpreted as Maddalena it will not be possible to trace its origin by means of the historical documents in the above mentioned texts).

A third database, which is complementary with the two ones we have been mentioning above, is instructed to the purpose of filing the executive methodologies of the different artists. Even in this case the data are divided into according to the materials used by the different artists, classified according to ages and geograhica areas. To this purpose we should consider that some pigments, often more precious ones, were used only by the Master, while the pupils had to be satisfied with a less rich and expensive palette. Moreover, some materials were difficult to be found and were often retrieved just in some geographical areas and, above all, in some ages.

An interesting study about the manufact can also be derived from the observation of the materials forming the work itself, such as the typologies of the wooden supports, of the canvas and of the other materials (to this purpose, the know-how of the universities and of all of those institutes dealing with chemical, radiographic, spectrograhic analys ad the lie would be very precious).

As a further support of what we mentioned above we think it is right to refer to the two following considerations.

Guercino allowed his pupils to paint using the colours of his palette and that is why nowadays the attribution of the works to the hand of the master can be derived just thanks to the high pictorial quality of his painting. Nevertheless, in the botega of the artist they painted by mixed pigments such as to leave “a vista” a rather sandy granulometry.

This feature, in the long run, will represent an important element for the recognition of these works including the ones coming from somewhere else but made at the same time and I the same area.

We often think, wrongly, that Leonardo da Vinci had painted very little. Instead, he was a keen painter and he made many images of Madonna with Child.

He often painted on a wooden support, but in many cases he preferred the soft Italian poplar, often exposed to the attack of wood eater insects. Moreover the painting subject often appears so slight and levigated such as to make it difficult to locate the painting.

Therefore, the innovative contents are both in the devices used to instruct the working procedure, both I the quality and in the quantity of the results. The last ones form that utural patrimony that turns out to e so claimed and laborious to be found.

What we have been saying by far can let us guess which unknown work is hidden behind such a harmonized work; where technology takes advantage of history to innovate the study and knowledge of an art so rich in misteries, connected with one another and set far from our knowledge by the running of time.

The useful information gained by means of the system “discovering a work of art”, connected with the know-how of the expert, essentially give out to an examination of the work, self-realized and carried out with a high sense of practice and economy.

Some of the uses of the project pertain to the field of “restauro” (exam of the materials), of the reconstruction of the missing parts (study of techniques), of the development of a complementary documentation, of the attribution of the author of a work, datation, geographical localization and description of the commits' motivations.

“Prior-Art Portion”

1. The system “Discovering a work of art”is a method or process of industrial working that, by means of the technical application of a scientific principle, and of an intellectual guideline, provides the immediate industrial results: the foundations or “sentences” (the sentences are the . . . “characterized by” . . . or “wherein the improvement comprises” . . . ).
The sentences come out from the interrogation of the system, they provide a claimed product: a lost information which is rediscovered by the verification of ordered data and identified because it represents the discovery of a consequent element.
Informatic Duplicity of Algorithms

2. As claimed in claim n. 1
By means of the discretization of the intellectual application we come to the clear productive duplicity.
Such a nature is replied, obviously, in the information field by the analysis and the implementation of different algorithms. The former faces the optimized research work and the careful comparison of objective data to produce different “sentences”. The latter, by means of forms of artificial intelligence, carries out the more complex investigation about the data introduced and elaborated by A1. By the use of iterative execution formulas, recursive ones and function model ones of A1 and A2 we get the claimed final considerations.
Analysis of Deduction Processes

3. As claimed in claim n. 1
Even at the deduction level there are two parallel processes which do not necessarily match with the two above mentioned algorithms. The basic process is addressed to the synthesis of the elements realizing the entity of the “work” in algebric and symbolic key to the purpose of bearing the equivalent of a multidimensional vector in a space ruled by laws and/or norms (sub-list of the revendications:technical specifications).
The evoluted process, or properly deductive, is addressed to the non-linear application of the laws and norms of vectorial space. The last ones can, somehow or others, be seen as elements of another space in evolution.
The concatenation of the two processes corresponds to the simpler expression of “data intelligent visit”.
Data Module and Complex Research

4. As claimed in claim n 1
The intellective capability of the visit and research module is obviously shared with the complex structure of the database, but nevertheless the contribution of the present stays significant to the purpose of the final considerations by means of the final applications of its modules (aptly deviced functions to the purpose of stressing time and space of the visit).
Such a module requires a high congruence of the relations and of the data of the database, monitorized by the functions of the submodules. This allows us to fix which is the utmost degree of complexity and disorder within which we can get sensed and productive outputs.
Irregular Interface Module

5. As claimed in claim n.1
The module includes al of the first degree information by: congruence, pertinence, synthassis, logics and consequence.
The verification of the voices sent to elaboration motor are taken into exam according to the following criteria:
use of stacks for the partial formulation of the question or of a partial value/meaning of it;
the self-formulation of potential parameters, more and more specific, based on the deth degree of the interrogation session;
the self-reorganization of a part or of the whole session of interrogation by means of excesses of contradictions, incongruence, fragmentation;
the research of general information, such as at the end of a database about the field, to help the user in the formulation of the question;
the dictionary of terms and words and therefore of the synonyms with the corresponding logical and interpretative classifications (functioning specifications and revendications);
the control panel dedicated to functions of: saving filing, creation of user profile (field, language, ad hoc idioms and analysis report management).
Industriality:

6. The “Discovery work of art” is an industrial process that can be applied in the whole field of art. Alongside with the repetition of the process we optimize the results because the information and the “sentences” get amore and more complete character, homogeneous and reliable in the results.
Materiality:

7. The process leads to a tangible result, i.e. the retrieval of all of those elements that give out to the recognition of the “subject” of the work of art, (for instance the name of the depicted saint) and its geographical and historical placement. This result, at the “present state of technique”,can be achieved by no other procedure (nowadays the scholar does not rely on a method which can trace back all of the historical information we can find in a manufact and take them into exam in an ordered way).
Therefore the analysis method or knowledge process of the “Penco System”also optimizes cost and time.
News:

8. The innovative character of the “Discovery work of art” consists of the realization of an intelligent interaction between a database (gathering all of the historical-iconographic information about a subject and a software system that correlates to re discover those lost elements we defined as “sentences” that form the “claimed product”.
Therefore both the historical data and the information procedure represent the “instrument ” by which the information procedure puts into practice the range of “new”research ways, which are new since they have never been used at “the present state of technique” and result of the application. We point out that in the following list of technical specifications, we can find some information that even appearing as vain is an essential part of it to understand and detect which are the revendications and why they represent an innovative element within the system.
The list of the technical specifications by which the software interrogates the database represents the revendications depending on point 8.
structure of the iconographic cards: each card is structured such that the contents be “homogeneous” with one another so that they can be orderly interrogated
research cards: the contents of the iconographic card are divided and ordered within some fields to be later interrogated by means of a structured research
the intellectual capability of the research and visit module is obviously shared with the complex structure of the database, therefore the iconographic cards are structured into free text or choice (single or multiple) fields. The card is associated with a cathegory (classification of the subject dealt with in the card) to enable the system to evolve and deal with different subjects (sacred and prophane iconography, etc)
structure of the attributes; the attribute is associated with a list of values guiding the research process. Each attribute belongs to a cathegory (sex, typology, etc) and to a list of values.
Each value can be associated with one or more guide images. Each value can be correated with the values of another attribute.
Attribute management: there is a list of attributes' typologies. For each typology they show the name (name of the typology), the description, an order number and the state (active or locked)
it is possible to manage the list of values of all attributes. For each value there are the values' name, the description, the correlation of that value with other ones (if there are other ones) and the weight (it is the property that indicates the weight the value has within the research system. The weight influences the score computation of the rearch's results. We can visualize the list of images associated with the values.
Some attributes are characterized by an interdependence (for instance the typology the physical aspect and the wearing depend on sex)
synonims' management: some terms have associated synoims. These synonyms are the lists of terms by which we express the same object, but a suitable list of those key-words the system has to weigh during the research even if they have not been inserted since they can be referred to it (mitre and pastoral are not synonims but they identify the typology and the wearing of the research's subject). The synonims have their own weight
the system allows us to research within the card by means of a procedure guided step by step, choosing values deriving from attributes. The values of the attributes dealk as terms of comparison generating the ordering of the results (share INDEX). We also allow free text attributes.
the free terms are researched just within specific fields, while I ther fields the system researchs even by words' fragments.
possibility of gaining new terms directly from the card deriving from the previous research.
we can correlate images with attributes
researchs and images can be filed
the research takes place according to the structuring of two different typologic characteristics of attributes: the free ones and the linking ones.
This distinction allows us to research within the system giving a higher stress to the most significant inputs to the purpose of optimizing the reliability of the result.
for the management of the dependencies of the linking attributes. The structure of the linking attributes of the system is realized by a subdivision according to sex, typology, wearing martiry etc, and it is realized as to make them depending on one another (Ex: typology, cardinal, layman, nun, etc depend on sex; or wearing: monk clothes, bishop clothes depend on typology)
Originality:

9. The “discovering a work of art” provides an added value because its product cannot be retrieved by means of the present research and diagnosis' instruments.
In fact, at the “present state of technique” there is o method identifying the “subject” depicted in a work of art, of whatsoever nature, taking advantage of the elements that can be seen in the representation of the manufact itself. Nowadays it is possible to study the subject if we already know their name, but there is no other method to identify the subject starting from the identifying attributes.
Problems Connected with “the Present State of Technique”
The great deal of information we can find in texts and documents nowadays, is brought to an intelligent comparison just in the minds of a few expert scholars of this field. Therefore, because of ovous human limits, here comes the lack of such a wide knowledge of the information such that we run the risk of making any final consideration not so efficient from the knowledge point of view.
Solutions proposed by means of the application of the system “Discovering a work of art”. In order to overtake this hindering here comes the realization of a flexible and dynamic instrument such as an oriented software procedure, by means of an innovative process, of the study, the diagnostics and the comparison of allegoric meanings of technical, historical and characteristic data of the work. The project consists of a new diagnostics procedure allowing us to fix a deal of certain elements about a work of art we are taking into exam and that will build a more correct starting point and above all a more circumscribed one to cope with the future studies.
By “certain elements” we mean all of the information that, at the “present state of technique”, are commended into the hands of the individual skill of the person who faces the study of the work. But unfortunately in most cases the results of diagnosis turn out to be in contrast with one another, even among scholars of equal rank. This problem often depends on the fact that one of the most objective difficulties consists of the research and the retrieval of the greatest possible deal of that information later “addressing” the phase of study.
The sentences deriving from the system “Discovering a work of art” represent that “claimed product” providing a “differentiation”of the present state of technique:
in the field of art;
for the expert of the field (we have evaluations of the experts of the field who expressed their opinion as to this). Moreover the “Comando dei Carabinieri Tutela Patrimonio Culturale” has gained the “Discovering a work of art”just by these criteria):
in the lack of evidence of what has been found (they documented and approved discoveries traced by the application of this project)
